(19) United States
(12) Patent Application Publication
(10) Pub. No.: US 2024/0427313 A1
(43) Pub. Date: Dec. 26, 2024

(54) Extended Reality (XR) Collaborative Environments

(71) Applicant: Georgia Tech Research Corporation, Atlanta, GA (US)

(72) Inventors: Colin Usher, Atlanta, GA (US); Konrad Ahlin, Atlanta, GA (US); Wayne D. Daley, Atlanta, GA (US); Benjamin Joffe, Atlanta, GA (US)

(21) Appl. No.: 18/684,568

(22) PCT Filed: Aug. 17, 2022
(86) PCT No.: PCT/US2022/075070

§ 371 Date: Feb. 16, 2024

Related U.S. Application Data
(60) Provisional application No. 63/234,452, filed on Aug. 18, 2021.

(51) Int. Cl. G05B 19/4155; G06F 3/0346; G06T 11/00

(52) U.S. Cl. CPC G05B 19/4155; G06F 3/0346; G06T 11/00; G05B 2219/40099; G06T 2200/24

(57) ABSTRACT

An exemplary embodiment of the present disclosure provides an extended reality (XR) system comprising an autonomous robotic device and a user interface. The autonomous robotic device can be located in a physical environment. The user interface can be configured to display an XR environment corresponding to at least a portion of the physical environment and receive an input from the user based on the user's perception in the XR environment. The autonomous robotic device can be configured to perform an autonomous action based at least in part on an input received from the user.

### CROSS-REFERENCE TO RELATED APPLICATIONS

This application claims the benefit of U.S. Provisional Application Ser. No. 63/234,452, filed on 18 Aug. 2021, which is incorporated herein by reference in its entirety as if fully set forth below.

### FIELD OF THE DISCLOSURE

The various embodiments of the present disclosure relate generally to extended reality (XR) collaborative systems.

### BACKGROUND

Manufacturing operations in natural spaces can be challenging, requiring significant amounts of human capital to execute needed operations. The value of human capital within manufacturing operations is the ability to accommodate the natural variability of raw material of interest, especially within these natural spaces. Traditionally, workers performing manufacturing operation roles are unable to work remotely and must physically be in manufacturing facilities to perform work related tasks. Prior attempts to provide remote work capabilities to workers in manufacturing operations were unfavorable as systems proved to be challenging to program and implement. Accordingly, there is a need for providing a collaborative environment between people and autonomous robotic devices to address the aforementioned challenges present in performing manufacturing operations in natural spaces.

### BRIEF SUMMARY

An exemplary embodiment of the present disclosure provides an extended reality (XR) system comprising an autonomous robotic device and a user interface. The autonomous robotic device can be located in a physical environment. The user interface can be configured to display an XR environment corresponding to at least a portion of the physical environment and receive an input from the user based on the user's perception in the XR environment. The autonomous robotic device can be configured to perform an autonomous action based at least in part on an input received from the user.

In any of the embodiments disclosed herein, the autonomous robotic device can be further configured to use a machine learning algorithm to perform autonomous actions.

In any of the embodiments disclosed herein, the machine learning algorithm can be trained using data points representative of the physical environment and inputs based on the user's perception in the XR environment.

In any of the embodiments disclosed herein, the machine learning algorithm can be further trained using data points indicative of a success score of the autonomous action.

In any of the embodiments disclosed herein, the autonomous robotic device can be configured to request the user of the XR system to provide the input.

In any of the embodiments disclosed herein, the autonomous robotic device can be configured to request the user of the extended reality system to provide the input when the robotic device is unable to use a machine learning algorithm to perform the autonomous action without the user's input.

In any of the embodiments disclosed herein, the user interface can be configured to receive the input from the user via a network interface.

In any of the embodiments disclosed herein, the XR system can further comprise one or more sensors configured to monitor at least one discrete data value in the physical environment and the user interface can be further configured to display the XR environment based at least in part on the at least one discrete data value.

In any of the embodiments disclosed herein, the XR system can further comprise user equipment that can be configured to allow the user to interact with the user interface.

In any of the embodiments disclosed herein, the user equipment can comprise a head mounted display (HMD) that can be configured to display the XR environment to the user.

In any of the embodiments disclosed herein, the user equipment can comprise a controller that can be configured to allow the user to provide the input based on a user's perception in the XR environment.

In any of the embodiments disclosed herein, the user interface can be further configured to monitor movement of the controller by the user and alter a display of the XR environment based on said movement.

Another embodiment of the present disclosure provides a method of using an extended reality (XR) system to manipulate an autonomous robotic device located in a physical environment. The method can comprise: displaying an XR environment in a user interface corresponding to at least a portion of the environment; receiving an input from a user based on the user's perception in the XR environment; and performing an autonomous action with the robotic device based, at least in part, on the input received from the user.

In any of the embodiments disclosed herein, the method can further comprise using a machine learning algorithm to perform autonomous actions with the autonomous robotic device.

In any of the embodiments disclosed herein, the method can further comprise training the machine learning algorithm using data points representative of the physical environment and inputs received from the user based on the user's perception in the XR environment.

In any of the embodiments disclosed herein, the method can further comprise further training the machine learning algorithm using points indicative of a success score of the autonomous action performed by the autonomous robotic device.

In any of the embodiments disclosed herein, the method can further comprise requesting the user of the XR system to provide the input.

In any of the embodiments disclosed herein, the method can further comprise requesting the user of the XR system to provide the input when the autonomous robotic device is unable to use a machine learning algorithm to perform the autonomous action without the user's input.

In any of the embodiments disclosed herein, receiving the input from a user can occur via a network interface.

In any of the embodiments disclosed herein, the method can further comprise interacting, by one or more additional users, with the XR environment to monitor the input provided by the user.

In any of the embodiments disclosed herein, the method can further comprise interacting, by the user using user equipment, with the user interface.

In any of the embodiments disclosed herein, the method can further comprise displaying the XR environment to the user on the head mounted display (HMD) wherein the user equipment comprises an HMD.

In any of the embodiments disclosed herein, the method can further comprise generating, by the user with the controller, the input based on the user's perception in the XR environment.

In any of the embodiments disclosed herein, the method can further comprise monitoring movement of the controller by the user and altering a display of the XR environment based on said movement of the controller.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides an illustration of a user providing an input within the extended reality (XR) environment to the user interface via user equipment, resulting in an autonomous action performed by the autonomous robotic device, in accordance with an exemplary embodiment of the present disclosure.

FIG. 2 provides an illustration of a sensor monitoring at least one discrete data value within a physical environment to assist, at least in part, to constructing the XR environment displayed to a user via the user interface, in accordance with an exemplary embodiment of the present disclosure.

FIG. 3 provides an illustration of a user interacting with the user interface via user equipment, in accordance with an exemplary embodiment of the present disclosure.

FIGS. 4-5 provides flow charts of example processes for using XR environments with autonomous robotic devices performing autonomous actions, in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

There is no such thing as a self-reliant robot, especially in the biological world. Therefore, tools that can provide easy and seamless collaboration between people and robotic devices to support manufacturing operations, especially within natural space, are needed. Tools, described herein, allow for advantages such as remote operation of machinery within manufacturing facilities to execute tasks and improve productivity, in comparison to the substantial costs posed by increasing human capital.

The collaborative extended reality (XR) system (100) can include the following elements: an autonomous robotic device (300) configured to perform autonomous actions, user interface (600) configured to display a XR environment, user equipment (400) configured to display the user interface (600) and allow a user (200) to interact with said user interface (600), and one or more sensors (500) configured to monitor at least one discrete data value within a physical environment.

For the purposes of explanation, the XR system (100) is discussed in the context of being applied to the poultry production industry. The disclosure, however, is not so limited. Rather, as those skilled in the art would appreciate, the XR system (100) disclosed herein can find many applications in various applications where it may be desirable to provide user input to assist in task completion. Within the poultry production industry, second and further processing operations require significant participation of human workers. Typically, tasks can be classified as either gross operations, which can include moving of whole products or sections thereof from machine to machine, or fine operations, which can include cutting or proper layering of raw material in packaging that could require more anatomical knowledge or dexterity to execute. Through using the claimed XR system (100) described herein, a user (200) can provide an input to an autonomous robotic device (300), via the user interface (600), to perform an autonomous action corresponding to the gross or fine operations in a poultry manufacturing facility.

As one who is skilled in the art can appreciate, an autonomous robotic device (300) is a class of devices that is different from a telerobotic device. Specifically, an autonomous robotic device (300) differs from a telerobotic device in that an autonomous robotic device (300) does not require the user's input to control each facet of the operation to be performed; rather telerobotic devices are directly controlled by users. Similarly, an autonomous action, performed by an autonomous robotic device (300), is an action that considers but is not identical to the instruction/input received from the user (200). In a poultry production application, for example, an autonomous robotic device (300) performing an autonomous action could be loading raw natural material onto a cone moving through an assembly line. Although the user's input could designate a point where the autonomous robotic device (300) should grasp the raw natural material, the autonomous robotic device (300) can subsequently determine a path to move the raw natural material from its current location to the cone independent of the user's input. In other words, the user (200) provides an input used by the autonomous robotic device (300) to determine where to grasp the raw natural material, but the robot autonomously makes additional decisions in order to move the raw natural material to the cone.

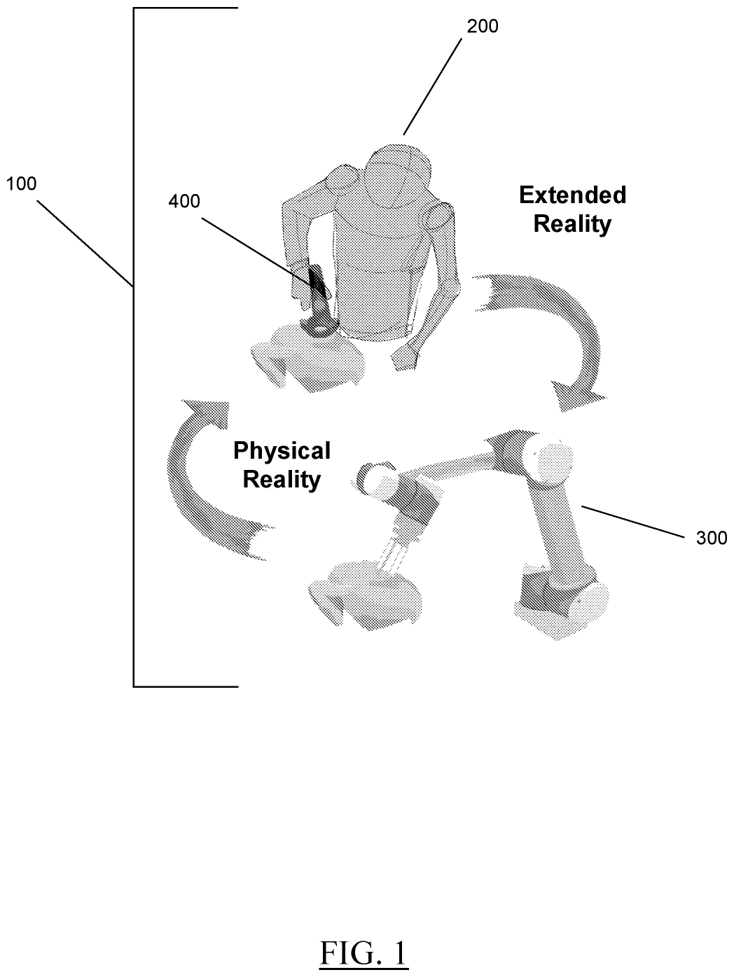

The user (200) of the XR system (100) can provide an input to the autonomous robotic device (300) to perform the autonomous action through using user equipment (400). The user equipment (400) can include many different components known in the art. For example, in some embodiments, the user equipment (400) can include a controller (420) and/or a head mounted display (HMD) (410), to allow the user (200) to interact with the user interface (600). In some embodiments, for example, HMD (410) could include but not be limited to an immersive display helmet, brain implant to visualize the transmitted display, and the like. FIG. 1 illustrates the user (200) using the controller (420) of the user equipment (400) to designate the grasp point of the raw natural material (e.g., where/how to grasp the poultry) within the XR system (100). The input can then be provided to the autonomous robotic device (300), which can then perform the autonomous action with the raw natural material (e.g., grasp the poultry and move it to the desired location). Due to the natural variability of conditions within tasks performed by the autonomous robotic device (300), the collaboration with the user (200) visualizing the XR environment using the user equipment (400) can allow the autonomous robotic device (300) to appropriately respond to real-time novel situations. This can occur by the user (200) utilizing prior experience and situational recognition to guide the autonomous actions performed by the autonomous robotic device (300) by interacting with the XR environment and providing an input to the user interface (600) via the user equipment (400). As one who is skilled in the art will appreciate, examples of user equipment (400) that the user (200) can use to interact with the user interface (600) can include but are not limited to an Oculus Quest II, Meta Quest II, and the like.

Within the XR system (100), the user interface (600) aggregates discrete data sets from one or more sensors (500). As one who is skilled in the art will appreciate, there are a plethora of different types of sensors, which can be configured to monitor discrete data values within a physical environment. Examples of different types of sensors can include but are not limited to temperature sensors, photo sensors, vibration sensors, motion sensors, color sensors, and the like. Within said XR system (100) the one or more sensors (500) can monitor discrete data sets within the physical environment, which can then be aggregated by the user interface (600) that can construct the XR environment to the user (200) that can be based at least in part on said discrete data sets and corresponding at least in part to the physical environment.

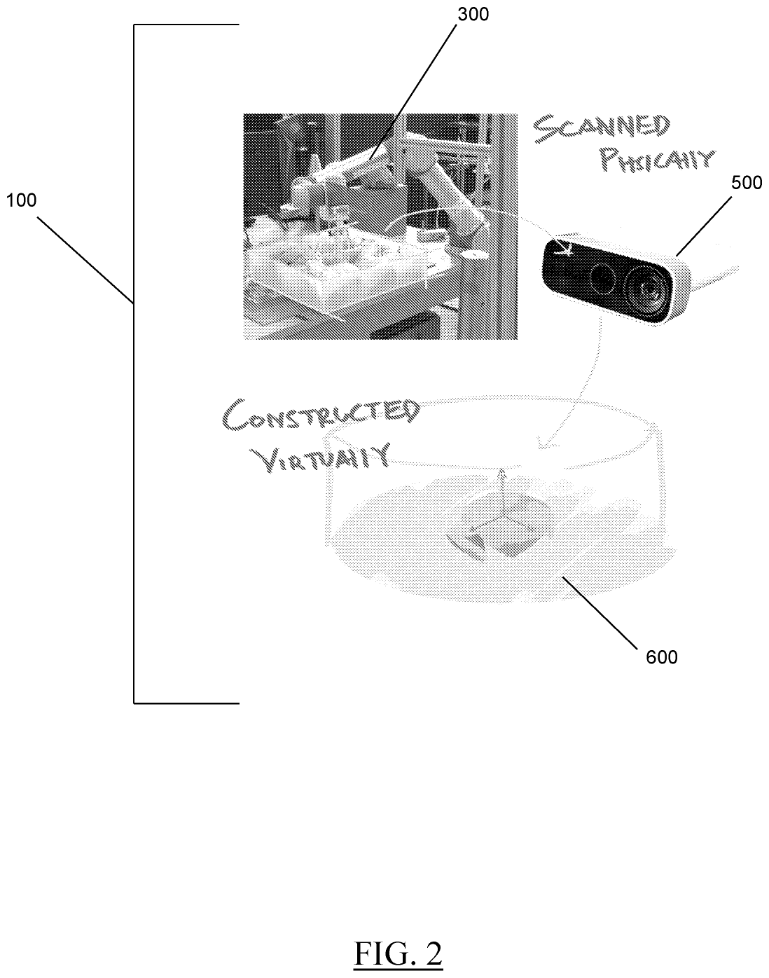

FIG. 2 illustrates the XR system (100) which includes the autonomous robotic device (300), located within the physical environment, the one or more sensors (500) monitoring at least one discrete data set within the physical environment, and the user interface (600) displaying the XR environment constructed at least in part by the discrete data sets monitored by the one or more sensors (500). The discrete data sets monitored by the one or more sensors (500) of the XR system (100), aside from contributing to the construction of the XR environment, can also assist the user (200) in making decisions within the XR environment and interacting with the user interface (600).

The user (200) can interact with the user interface (600) which displays the constructed XR environment, based in part on the discrete data sets monitored by the one or more sensors (500), using the user equipment (400). The user interface (600) can be displayed to the user (200) through the HMD (410) of the user equipment (400). As one who is skilled in the art will appreciate, the use of the HMD (410) to display the user interface (600) and therein the XR environment can assist the perception of the user (200) when interacting with the user interface (600). Additionally, through use of the HMD (410), the user (200) can determine input points that can be provided to the user interface (600) via the controller (420). The input provided by the user (200) can be received by the user interface (600) and transmitted to the autonomous robotic device (300) via a network interface. As one who is skilled in the art will appreciate, a network interface can be a medium of interconnectivity between two devices separated by large physical distances. Examples of a medium of interconnectivity relating to the preferred application can include but is not limited to cloud based networks, wired networks, wireless (Wi-Fi) networks, Bluetooth networks, and the like.

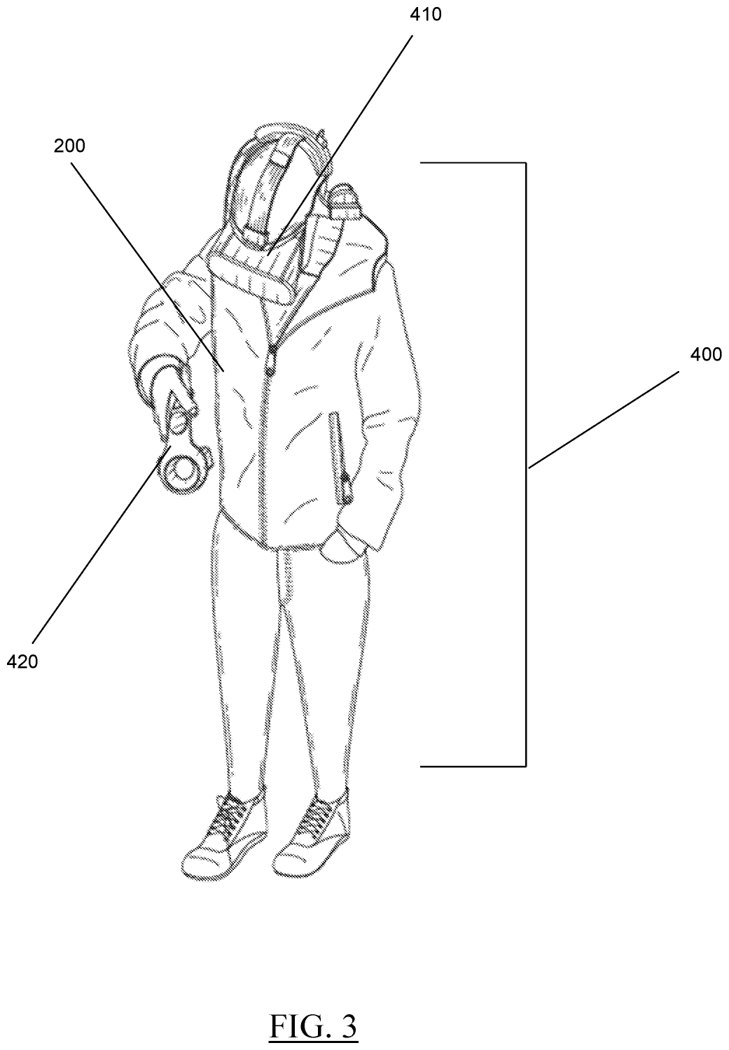

FIG. 3. Illustrates the user (200) with the HMD (410) and controller (420) of the user equipment (400) navigating within the XR environment and interacting with the user interface (600). In some embodiments, the user (200) can provide the grasping point of the raw natural material to the user interface (600) that can transmit said input to the autonomous robotic device (300), located a large physical distance from the user (200) via the network interface, and can perform the autonomous action such as placing the raw natural material on the cone apparatus. In some embodiments, the user (200) can use the user equipment (400) to provide multiple inputs to an autonomous robotic device (300) via the user interface (600) to provide guidance for a longer enduring process. For example, if the user (200) is monitoring a process that requires multiple inputs to the user interface (600) over time to perform autonomous actions by the autonomous robotic device (300), the claimed invention can support this capability. Examples of the user (200) providing multiple inputs during a process could be applied to opportunities including but not limited to a commercial baking oven, agricultural production operations, and the like. A commercial baking oven, for example, takes in kneaded dough which demonstrates some properties over time, such as the ability to rise. The dough then goes through the oven and is baked. The output color of the dough is monitored to meet specifications. Due to the natural variability in a wheat yeast mixture, oven parameters may need to be manipulated throughout the process to achieve the desired output. These parameters can include but are not limited to temperature, dwell time, humidity, and the like. The ability to manipulate the oven parameters throughout the baking process can be implemented using the XR system (100) described herein. The XR system (100) can enable the user (200) to provide multiple inputs to an autonomous robotic device (300) that can perform multiple autonomous actions during a process. Additionally, the XR system (100) can enable the user (200) to be “on the line” while the process is running, allowing the user (200) to provide multiple necessary inputs in real time, and can allow the user (200) to monitor parts of the process in a physical environment that could be physically unreachable or dangerous for people.

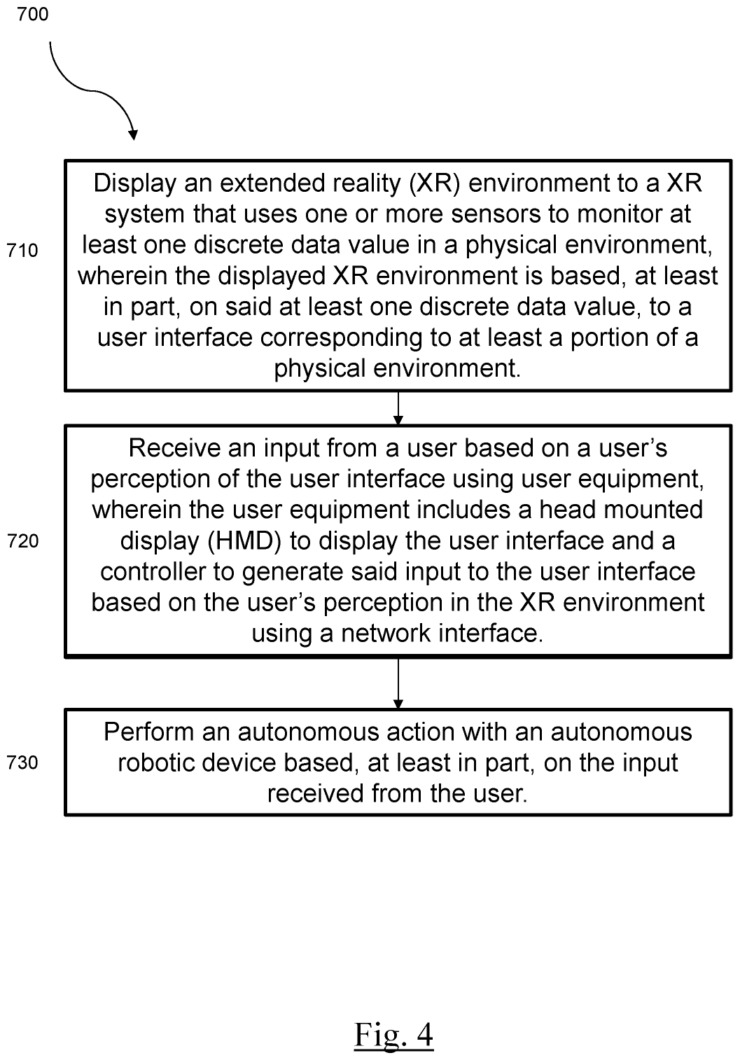

FIG. 4. illustrates a method flow chart (700) describing how a user (200) can provide an input to the XR system (100) that can result in the autonomous robotic device (300) performing an autonomous action. The method can comprise (710) initializing the XR system (100) and displaying the XR environment, constructed based at least in part on the discrete data sets monitored by one or more sensors (500) that can correspond to at least a portion of the physical environment. The method can further comprise (720) receiving the input from the user (200), via a network interface, based on the user's perception of the user interface (600) using user equipment (400) wherein the user equipment (400) includes an HMD (410) to display the user interface (600) to the user (200) and a controller (420) to generate said input within the XR environment. The method can further comprise (730) the autonomous robotic device (300) performing an autonomous action based, at least in part, on the input received from the user (200).

The autonomous robotic device (300) of the XR system (100) can also be configured to use a machine learning algorithm to carry out autonomous actions, without an input from the user (200). This configuration can be desirable as it can increase productivity within manufacturing operations, specifically enabling the autonomous robotic device (300) to perform repetitive tasks at a high rate of efficiency while considering natural variability of the raw natural material. The natural variability described previously, in the preferred application, could include but is not limited to positioning of the raw natural material to be grasped for a gross operation or varying anatomical presentation of the raw material for a fine operation. As one who is skilled in the art will appreciate, a machine learning algorithm is a subfield within artificial intelligence (AI) that enables computer systems and other related devices to learn how to perform tasks and improve performance in performing tasks over time. Examples of types of machine learning that can be used can include but are not limited to supervised learning algorithms, unsupervised learning algorithms, semi-supervised learning algorithms, reinforcement learning algorithms, and the like. In addition to the aforementioned examples, other algorithms that are not only based on machine learning or AI can be utilized with the autonomous robotic device (300) to perform autonomous actions such as deterministic algorithms, statistical algorithms, and the like. In some embodiments, if the machine learning algorithm is unable to be used to complete the autonomous action due to natural variability of the raw material, the XR system (100) can request the user (200) to provide an input to the user interface (600) that can be transmitted to the autonomous robotic device (300) via the network interface to perform the autonomous action. This collaboration by requesting the user (200) to provide an input to the autonomous robotic device (300) to complete the autonomous action can also be advantageous as it allows the user (200) to further train the autonomous robotic device (300) beyond performing the immediate intended autonomous action. The input provided by the user (200) to the autonomous robotic device (300) can also be used to support the development of specific autonomous action applications to be used by the autonomous robotic device (300).

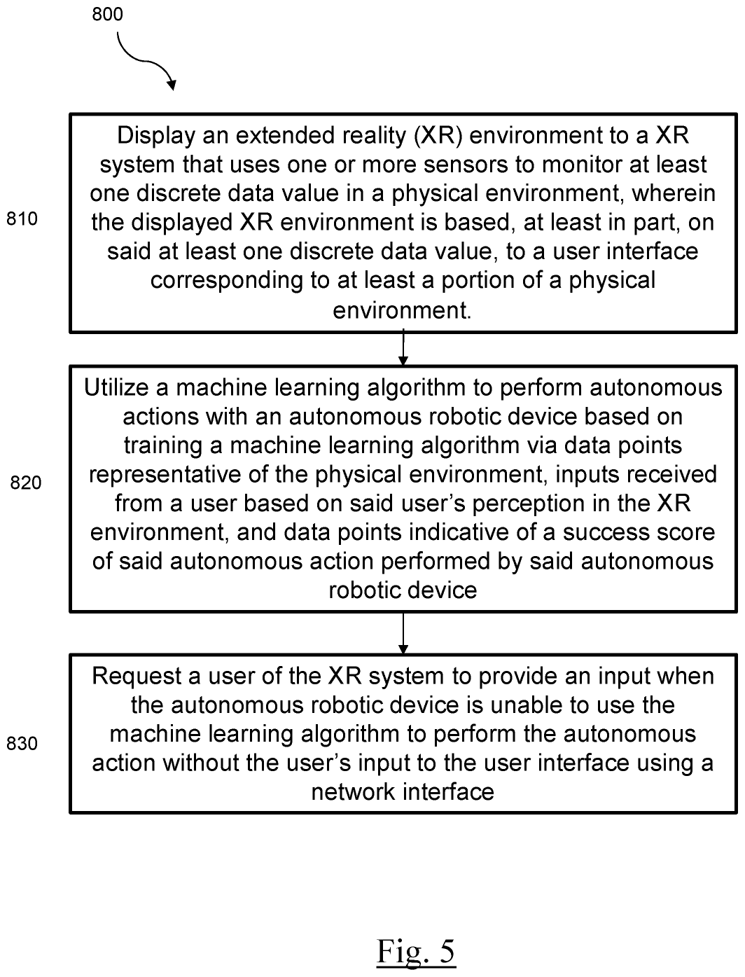

FIG. 5 illustrates a method flow chart (800) describing how an autonomous robotic device (300) can perform autonomous actions using the machine learning algorithm. The method (810) can comprise initializing the XR system (100) and displaying the XR environment, constructed based at least in part on the discrete data sets monitored by one or more sensors (500) that can correspond to at least a portion of the physical environment. The method can further comprise (820) the autonomous robotic device (300) utilizing the machine learning algorithm to perform autonomous actions that can be trained based on data points representative in the physical environment, historical input data from the user (200) based on user perception in the XR environment, and data points indicative of a success score of said autonomous actions performed by said autonomous robotic device (300). The method can further comprise (830) the XR system (100) requesting the user (200) to provide an input to the user interface (600) if the autonomous robotic device (300) is unable to perform the autonomous action using the machine learning algorithm. For example, if the autonomous robotic device (300) determines a predicted success score for the autonomous action, the XR system (100) can request the user (200) to provide an input, which can increase the likelihood that the autonomous action will be successfully completed.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. An extended reality (XR) system comprising:
an autonomous robotic device located in a physical environment at a device location;
a user interface configured to:
construct an XRII environment corresponding to at least a portion of the physical environment;
receive an input from a user at a user location interacting with the XR environment, the input based on the user's perception in the XR environment; and
transmit the input to the autonomous robotic device;
wherein the user location is remote from the device location;
wherein the user interface is further configured to transmit the input within a range of latencies; and
wherein the autonomous robotic device is configured to perform an autonomous action based, at least in part, on the input transmitted by the user interface.

2. The XR system of claim 1, wherein the user location is physically remote from the device location.

3. The XR system of claim 2, wherein the wherein the input is transmitted to the autonomous robotic device via a network interface; and
wherein the physically remoteness between the device location and the user location is such that the user's perception of the physical environment is only through the XR environment.

4. The XR system of claim 3, wherein the autonomous robotic device is further configured to use a machine learning algorithm to perform the autonomous action;
wherein the machine learning algorithm is trained using data points representative of the physical environment and indicative of a success score of the autonomous action, and inputs received from the user based on the user's perception in the XR environment.

5. The XR system of claim 3, wherein the autonomous robotic device is further configured to request the user of the XR system to provide the input.

6. The XR system of claim 5, wherein the autonomous robotic device is further configured to request the user of the XR system to provide the input when the autonomous robotic device is unable to use a machine learning algorithm to perform the autonomous action without the user's input.

7. The XR system of claim 3, wherein the user interface is configured to receive the input from the user via the network interface.

8. The XR system of claim 3, wherein the user interface is further configured to enable one or more additional users to interact with the XR environment.

9. The XR system of claim 3 further comprising one or more sensors at the device location configured to monitor at least one discrete data value in the physical environment;
wherein the user interface is further configured to display the XR environment based, at least in part, on at least one discrete data value.

10. The XR system of claim 3 further comprising user equipment configured to allow the user to interact with the XR environment.

11. The XR system of claim 10, wherein the user interface is further configured to display the constructed XR environment; and
wherein the user equipment comprises a head mounted display (HMD) configured to display the XR environment to the user.

12. The XR system of claim 10, wherein the user equipment comprises a controller configured to allow the user to provide the input.

13. The XR system of claim 10, wherein the user interface is further configured to display the constructed XR environment;
wherein the user equipment comprises:
a HMD configured to display the XR environment to the user; and
a controller configured to allow the user to provide the input; and
wherein the user interface is further configured to monitor movement of the controller by the user and alter the display of the XR environment based on one or more monitored movements.

14. A method comprising:
constructing an extended reality (XR) environment corresponding to at least a portion of a physical environment at a device location in which an autonomous robotic device is located;
receiving an input from a user at a user location interacting with the XR environment, the input based on the user's perception of the physical environment being only through the XR environment;
transmitting the input to the autonomous robotic device via a network interface, being a medium of interconnectivity between the user location and the autonomous robotic device, which can be separated by a large physical distance; and
performing an autonomous action with the autonomous robotic device based, at least in part, on the transmitted input. pepper

15. The method of claim 14, wherein the performing is further based, at least in part, by using a machine learning algorithm.

16. The method of claim 15, wherein the machine learning algorihm has been trained using data points representative of the physical environment, data points indicative of a success score of the autonomous, and inputs received from the user based on the user's perception in the XR environment.

17.-18. (canceled)

19. The method of claim 14 further comprising requesting the user of the XR system to provide the input when the autonomous robotic device is unable to use a machine learning algorithm to perform the autonomous action without the user's input.

20.-21. (canceled)

22. The method of claim 14 further comprising:
displaying the constructed XR environment; and
monitoring, with one or more sensors at the device location, at least one discrete data value in the physical environment;
wherein the displayed XR environment is based, at least in part, on the at least one discrete data value.

23. The method of claim 22 further comprising interacting, by the user using user equipment, with the XR environment.

24. The method of claim 14 further comprising:
displaying the XR environment to the user on a head mounted display (HMD);
generating, by the user, with a controller, the input;
monitoring movement of the controller by the user; and
altering the display of the XR environment based on the monitored movement.

25.-26. (canceled)
